(19) United States
(12) Patent Application Publication
(10) Pub. No.: US 2009/0122334 A1
(43) Pub. Date: May 14, 2009

(54) PRINTING SYSTEM

(75) Inventor: Taku SONEOKA, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/250,848

(22) Filed: Oct. 14, 2008

(30) Foreign Application Priority Data
Nov. 9, 2007 (JP) 2007-292430

(51) Int. Cl. G06F 3/12

(52) U.S. Cl. 358/1.15

(57) ABSTRACT

A printing system includes a printing machine and a terminal device that are mutually connected via a network. When an instruction for new authentication data registration is given by the terminal device at a time of receiving an instruction for security printing, the printing machine receives the instruction for the registration. When newly received authentication data is input from an operation unit, the printing machine permits printing of print data in accordance with the instruction for the security printing.

### CROSS-REFERENCE TO RELATED APPLICATIONS

This application claims priority under 35 U.S.C. 119 to Japanese Patent Application No. 2007-292430, filed on Nov. 9, 2007, which application is hereby incorporated by reference in its entirety.

### BACKGROUND OF THE INVENTION

1. Field of the Invention

The present invention relates to a printing system that performs security printing.

2. Description of the Related Art

When performing security printing using a conventional printing system, it is necessary to register a user in a printing machine in advance, or the like. In response to an instruction for the security printing given by a terminal device, when it is confirmed that pre-registered authentication data has been input from an operation unit of the printing machine, the printing machine permits printing of print data in accordance with the instruction for the security printing.

However, when performing security printing using the above-described conventional printing system, it is necessary to register the user in the printing machine in advance, or the like. Therefore, an unregistered user or a user unaware of his/her registration status, for example, cannot use the security printing function.

### SUMMARY OF THE INVENTION

In order to overcome the problems described above, preferred embodiments of the present invention provide a printing system in which even an unregistered user or a user unaware of his/her registration content, for example, can easily and immediately perform security printing.

A preferred embodiment of the present invention provides a printing machine and a terminal device that are mutually connected via a network. In response to an instruction for security printing given by the terminal device, the printing machine permits printing of print data in accordance with the instruction for the security printing when it is confirmed that pre-registered authentication data has been input from an operation unit of the printing machine. When an instruction for registration of new authentication data is given at the time of receiving the instruction for the security printing via the terminal device, the printing machine receives the instruction for the registration. When the newly received authentication data is input from the operation unit, the printing machine permits the printing of the print data in accordance with the instruction for the security printing.

According to a further preferred embodiment of the present invention, the terminal device includes a control unit and a display unit. The control unit displays an authentication data input screen for security printing on the display unit. The input screen has a registration button arranged to receive the instruction for the new registration from a user.

According to a further preferred embodiment of the present invention, the input screen displayed on the display unit of the terminal device is created by using a browser installed on the control unit.

According to a further preferred embodiment of the present invention, the input screen displayed on the display unit of the terminal device is created by using driver software installed on the control unit for cooperating with the printing machine.

According to a preferred embodiment of the present invention, when the printing machine receives the instructions for the security printing via the terminal device, if the instruction for the registration of new authentication data is also given, the printing machine receives the instruction for the registration. When the newly received authentication data is input from the operation unit, the printing machine permits the printing of the print data in accordance with the instruction for the security printing. Therefore, even an unregistered user and a user unaware of his/her registration content can easily and immediately perform the security printing.

According to a further preferred embodiment of the present invention, since the new registration of the user can be performed on the authentication data input screen displayed at the terminal device for the security printing, the registration can be easily performed.

According to a further preferred embodiment of the present invention, since the authentication data input screen for the security printing is created by using the browser, it is not necessary to install special software on the terminal device for creating the input screen, thereby improving convenience.

According to a further preferred embodiment of the present invention, since the authentication data input screen for the security printing is created by using the driver software arranged to cooperate with the printing machine, it is not necessary to install the special software on the terminal device for creating the input screen, thereby improving convenience.

Other features, elements, processes, steps, characteristics, and advantages of the present invention will become more apparent from the following detailed description of preferred embodiments of the present invention with reference to the attached drawings.

### BRIEF DESCRIPTION OF THE DRAWINGS

FIG. 1 is a block diagram of a document processing system that defines a printing system according to a preferred embodiment of the present invention.

FIG. 2 is a flowchart of processes of security printing performed by the document processing system of FIG. 1.

FIG. 3 illustrates a print setting screen displayed by a terminal device.

FIG. 4 illustrates an authentication data input screen displayed by the terminal device.

FIG. 5 illustrates a printer mode screen displayed by a facsimile Multi Function Peripheral (MFP).

FIG. 6 illustrates a login screen displayed by the facsimile MFP.

FIG. 7 illustrates a list screen that is displayed by the facsimile MFP and displays print data stored in a security printing box.

### DETAILED DESCRIPTION OF PREFERRED EMBODIMENTS

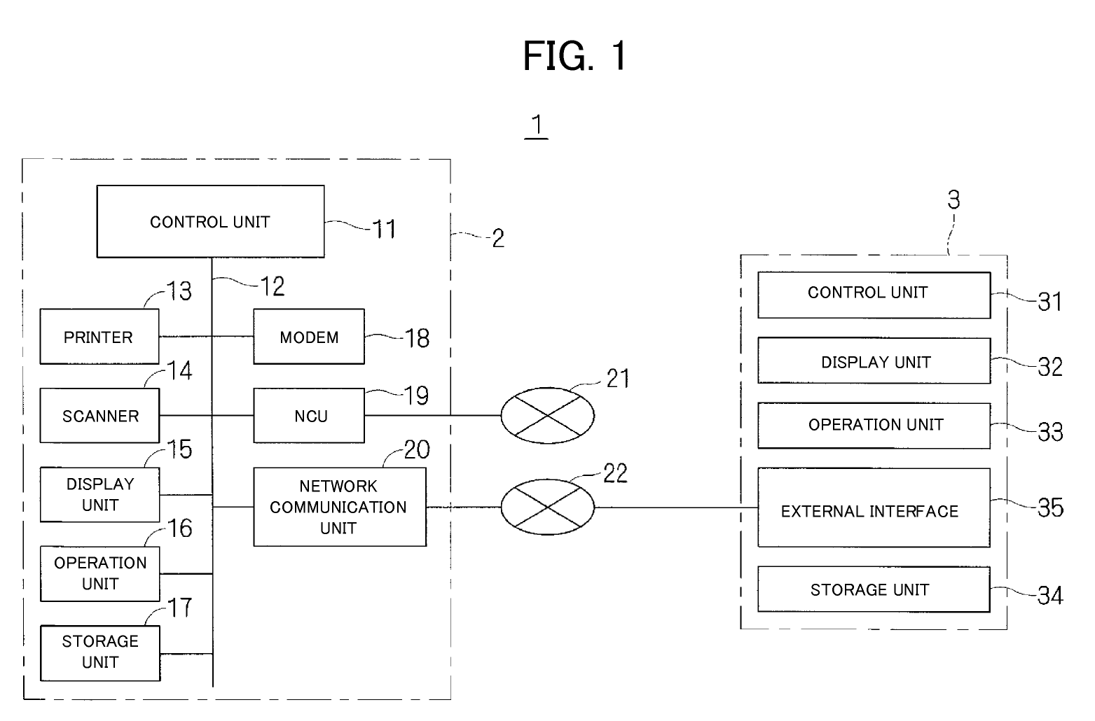

FIG. 1 is a block diagram of a document processing system that defines a printing system according to a preferred embodiment of the present invention. As illustrated in FIG. 1, a document processing system 1 includes a facsimile Multi Function Peripheral (hereinafter, referred to as the “MFP”) 2, which includes a printing machine, and at least one terminal device 3. The terminal device 3 may be a personal computer (PC), or the like. The MFP 2 and the terminal device 3 are connected via a network (for example, via a Local Area Network) 22.

The MFP 2 may preferably include a printer function, a facsimile function, an Internet facsimile function, a copier function, a scanner function, etc. The MFP 2 can also execute each of the above-described functions in accordance with instructions given to it by the terminal device 3.

As illustrated in FIG. 1, the MFP 2 includes a control unit 11, a printer 13, a scanner 14, a display unit 15, an operation unit 16, a storage unit 17, a modem 18, a Network Control Unit 19, and a network communication unit 20. The printer 13, scanner 14, display unit 15, operation unit 16, storage unit 17, modem 18, Network Control Unit 19, and network communication unit 20 are connected with the control unit 11 via a bus 12.

The control unit 11 controls the entire MFP 2, and includes a Central Processing Unit (CPU), etc. The printer 13 is an electrophotographic printing machine, for example, and prints, on a recording paper, etc., print data received from the terminal device 3, image data scanned by the scanner 14, and image data received via facsimile, or the like. The scanner 14 is used to scan an original document at the time of facsimile transmission and at the time of using the copier function and the scanner function, or the like.

The display unit 15 preferably includes a Liquid Crystal Display (LCD), or the like, and is used to display operation data, etc., of the MFP 2. The operation unit 16 preferably includes a plurality of operation buttons and a touch screen configured in cooperation with the display unit 15, and is used to perform operations of the MFP 2.

The storage unit 17 includes a Read Only Memory (ROM) and a Random Access Memory (RAM), or the like. The storage unit 17 stores a control program executed by the control unit 11, various pieces of setting data of the MFP 2, and phonebook data, for example. The storage unit 17 also stores print data transmitted from the terminal device 3, facsimile image data transmitted and/or received via the NCU 19 at the time of using the facsimile function, and image data scanned at the time of using the copier function and the scanner function, or the like. Moreover, the storage unit 17 stores authentication data (for example, a user ID and a password) for authentication regarding, for example, authorization of security printing with respect to each user.

The modem 18 is a facsimile modem capable of facsimile communication. The modem 18 is directly connected with the NCU 19. The NCU 19 is a hardware device which connects and disconnects a line with an analog Public Switched Telephone Network (PSTN) 21, and if necessary, connects the modem 18 with the PSTN 21.

The network communication unit 20 performs data communication via the network (a LAN and an external network such as the Internet, for example) 22. More specifically, the network communication unit 20 includes a function of handling a Simple Mail Transfer Protocol (SMTP), a Post Office Protocol (POP), a Server Message Block (SMB), and a Hyper Text Transfer Protocol (HTTP), or the like. Specific functions of the network communication unit 20 include transmission and reception of electronic mails (e-mails), transmission and reception of Internet facsimile in which image data is attached to an e-mail and either transmitted or received, and transmission and reception of data performed via the LAN or the Internet, or the like.

As illustrated in FIG. 1, the terminal device 3 includes a control unit 31, a display unit 32, an operation unit 33, a storage unit 34, and an external interface 35.

The control unit 31 controls the entire terminal device 3, and includes a CPU, etc. The display unit 32 includes an LCD, or the like, and is used to display operation data, etc. of the terminal device 3. The operation unit 33 includes a plurality of operation keys, etc., and is used to perform operations of the terminal device 3.

The storage unit 34 includes a storage device, such as a ROM and a RAM, and stores a control program executed by the control unit 31 and data regarding settings and maintenance management, or the like, of the terminal device 3.

The external interface 35 is an interface that connects the terminal device 3 with the network (for example, the LAN and the external network such as the Internet) 22. The control unit 31 includes a function of handling the SMTP, POP, SMB, HTTP, etc. in cooperation with the external interface 35.

The document processing system 1 of the present preferred embodiment includes a security printing function. In the security printing function, when an instruction for security printing is given by the terminal device 3 via the network communication unit 20, the control unit 11 of the MFP 2 does not immediately print, but just retains print data specified in the instruction for the security printing. At this time, the received print data is stored in a security printing box provided in the storage unit 17. Then, when it is confirmed that pre-registered authentication data regarding authorization of security printing has been input from the operation unit 16, the control unit 11 permits the printing of the print data in accordance with the instruction for the security printing.

When an instruction for registration of new authentication data (i.e., for new user registration) is received via the terminal device 3 along with the instruction for the security printing, the control unit 11 of the MFP 2 receives the instruction for the registration along with the instruction for the security printing.

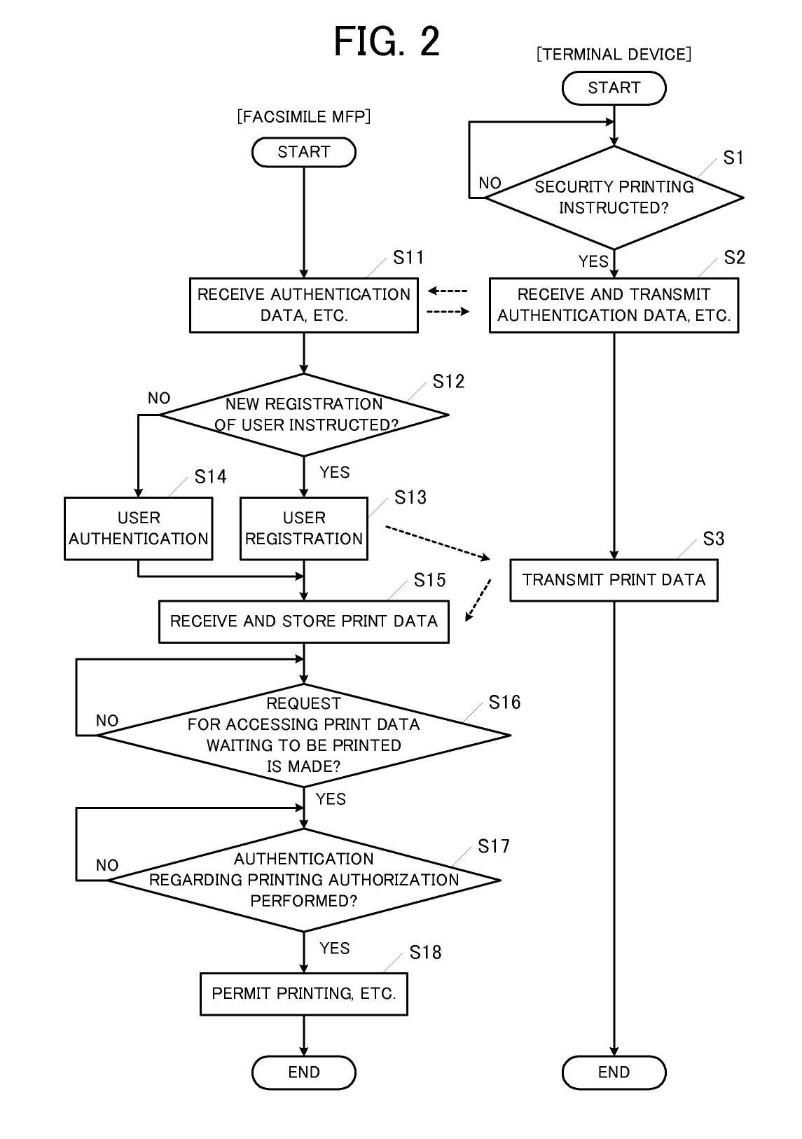

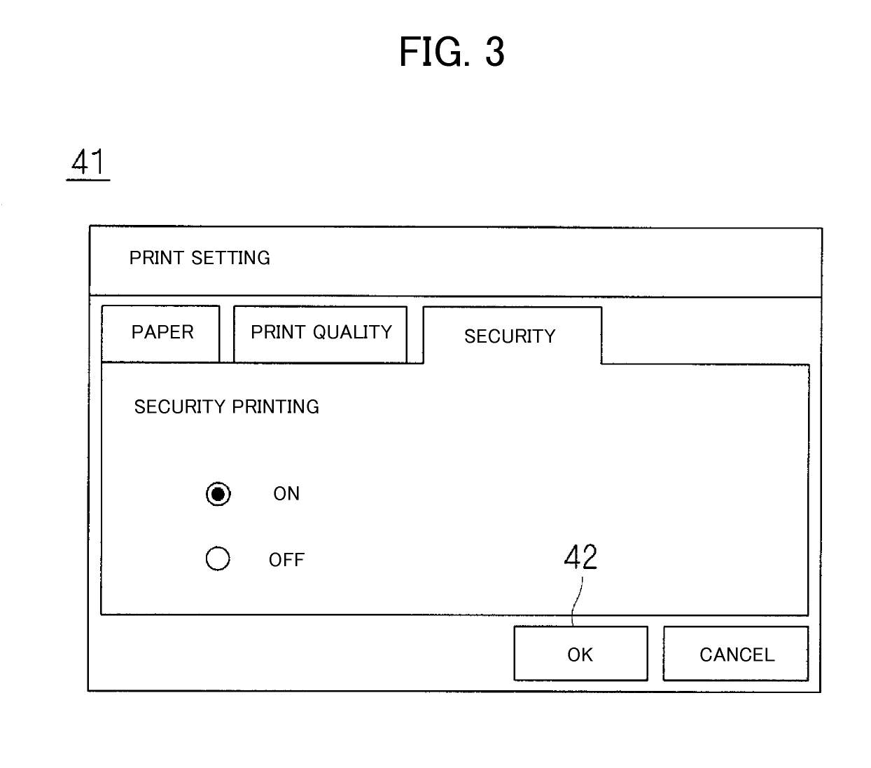

FIG. 2 is a flowchart illustrating processes of the security printing performed by the document processing system according to a preferred embodiment of the present invention. As illustrated in FIG. 2, the control unit 31 of the terminal device 3 determines whether or not the instruction for the security printing has been input from the operation unit 33, or the like (step S1). For example, the instruction for the security printing is given when a user gives an instruction for printing by selecting document data (print data) to be printed, opens a print setting screen 41 illustrated in FIG. 3, turns on the setting regarding the security printing, and operates (for example, clicks) an OK button 42. The print setting screen 41 is created by using driver software (such as a printer driver) installed on the terminal device 3 for cooperating with the MFP 2.

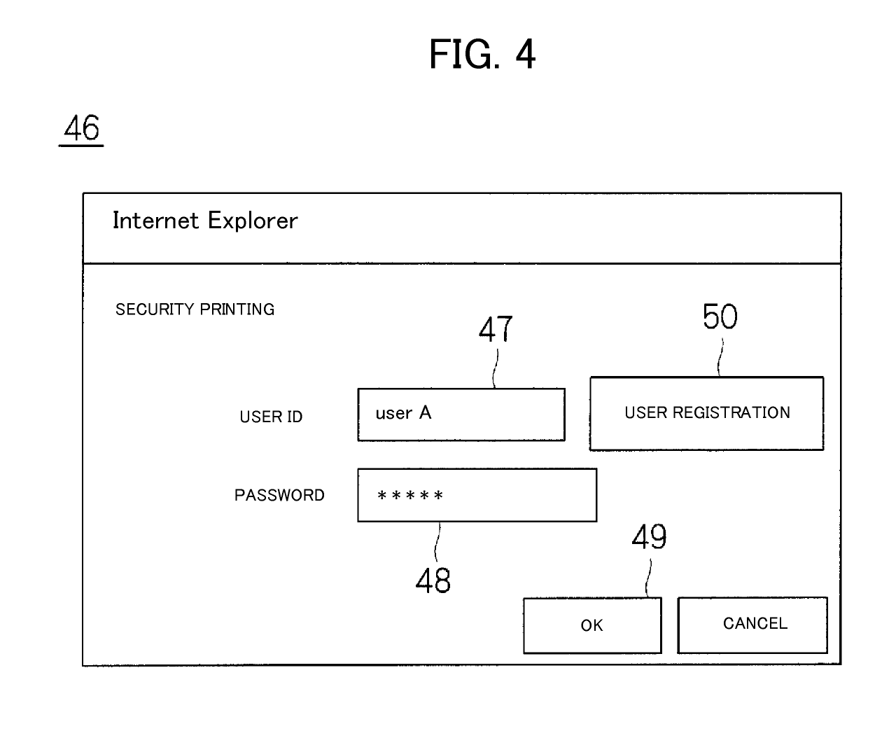

Then, in cooperation with the MFP 2, the control unit 31 of the terminal device 3 receives and transmits the authentication data for the security printing via the operation unit 33, or the like (step S2). More specifically, when the instruction for the security printing is input, a prescribed command (for example, a printing command) is transmitted from the terminal device 3 to the MFP 2. After a response from the MFP 2 responding to the command, an authentication data input screen 46 (refer to FIG. 4) for the security printing is displayed on the display unit 32. The input screen 46 is created by using a browser (such as an Internet Explorer (trademark)) installed on the terminal device 3.

The input screen 46 of FIG. 4 includes an input area 47 for inputting a user ID as authentication data and an input area 48 for inputting a password. A registered user can input his/her user ID and password in the input areas 47, 48 and operate (for example, click) an OK button 49. At this time, when the user is already logged into the MFP 2, the user ID is displayed in the input area 47 in accordance with the display on the input screen 46, and the input of the user ID is exempted.

A registration button 50 for receiving new registration of a user is provided on the input screen 46 of FIG. 4 for use by an unregistered user or a user who has registered but is unaware of his/her authentication data. The user that desires the new registration may input a proper user ID and password in the input areas 47, 48, for example, and operate (for example, click) the registration button 50.

The input authentication data and instruction for the new registration of the user, etc., are transmitted by the control unit 31 to the MFP 2 via the external interface 35.

The control unit 11 of the MFP 2 receives the authentication data and the instruction for the new registration of the user from the terminal device 3 via the network communication unit 20 (step S11). In step S11, the response to the printing command, or the like, transmitted from the terminal device 3 is also output.

Then, the control unit 11 of the MFP 2 determines whether or not the instruction for the new registration of the user has been given in step S11 (step S12). When the instruction for the new registration has been given, the control unit 11 performs the new registration of the user with respect to the storage unit 17 based on the authentication data received in step S11 (step S13). When the instruction for the new registration has not been given, the control unit 11 cross-checks the authentication data received in step S11 with authentication data pre-registered in the storage unit 17, and performs authentication (step S14). Accompanying the completion of the new registration of the user or the authentication, the control unit 11 notifies the terminal device 3 of the completion of the authentication, etc., via the network communication unit 20.

In response to the notification of the completion of the authentication, etc., from the MFP 2, the control unit 31 of the terminal device 3 transmits, to the MFP 2 via the external interface 35, the print data to be printed (step S3).

The control unit 11 of the MFP 2 receives the print data from the terminal device 3 via the network communication unit 20, and stores the print data in the storage unit 17 (step S15). The security printing box provides storage space for use with respect to each user (or with respect to each group to which each user belongs) in the storage unit 17. The print data is stored in the security printing box that corresponds to the authentication data received in step S11. When accessing the security printing box, the input of the authentication data is required.

Then, the control unit 11 determines whether or not a request for accessing the stored print data on which the security printing will be performed has been made via the operation unit 16, and waits until the request for accessing the print data is made (step S16). When the request for accessing the print data is made, the control unit 11 determines whether or not the authentication data for the security printing has already been input via the operation unit 16 (step S17). At this time, when the authentication data has not been input, the control unit 11 displays the authentication data input screen on the display unit 15, and receives the input of the authentication data via the operation unit 16, or the like.

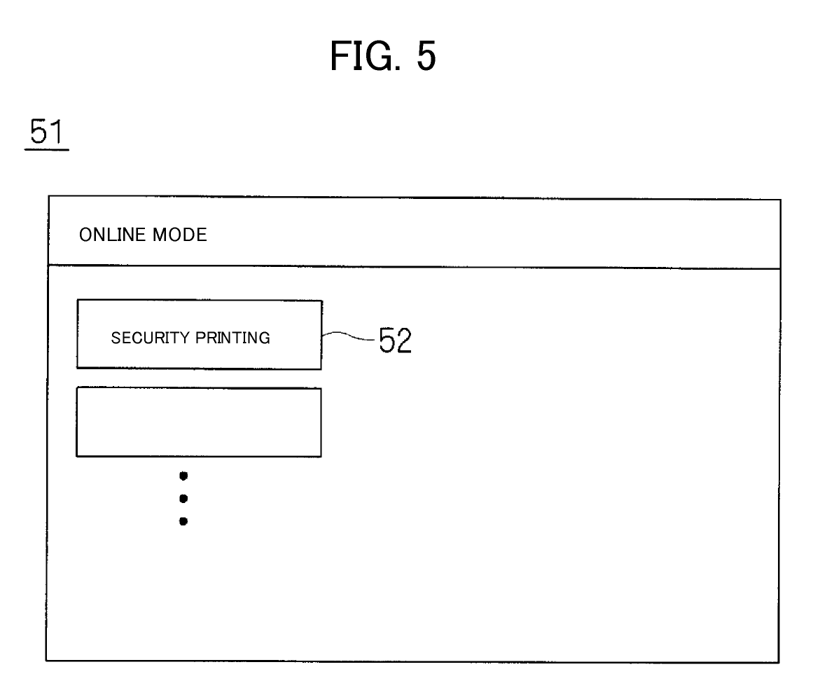

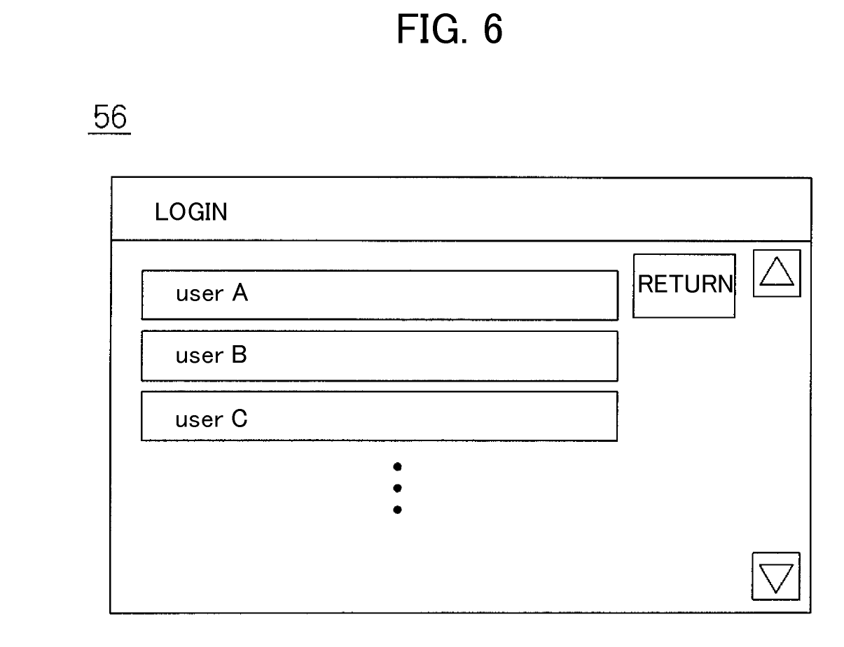

More specifically, after instructing the MFP 2 via the terminal device 3 to perform the security printing, the user goes to the MFP 2, and enables the security printing function by operating the operation unit 16 of the MFP 2. As illustrated in FIG. 5, for example, the security printing function is preferably enabled by opening a printer mode screen 51 displayed on the touch screen of the MFP 2, and by operating (for example, pressing) a security printing button 52 on the screen 51. As illustrated in FIG. 6, for example, when the security printing button 52 is operated, a login screen 56, which is the authentication data input screen, is displayed on the touch screen. The login screen 56 displays a list of user IDs of the registered users. The user selects his/her user ID from the user IDs displayed on the login screen 56, and inputs his/her password on a subsequently displayed password input screen (not illustrated) to log in.

When the authentication is smoothly confirmed or received in step S17, the control unit 11 permits the user to access the security printing box, and thus, the printing, or the like, of the print data stored in the security printing box can be performed (step S18).

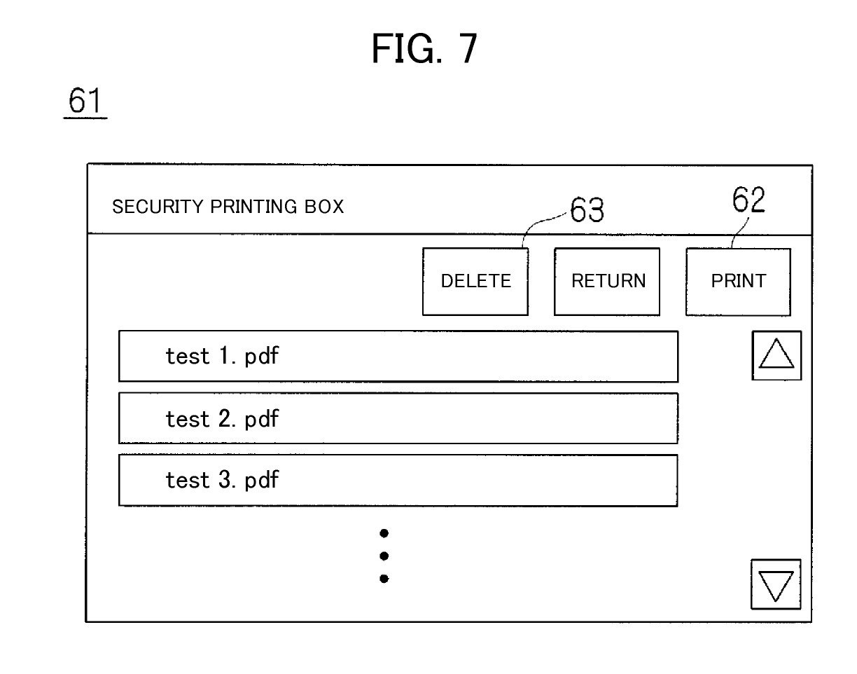

More specifically, when the confirmation of the authentication, etc., in step S17 is smoothly completed, a list screen 61 of the print data waiting to be printed is displayed on the touch screen as illustrated in FIG. 7, for example. A list of print data stored in the access-permitted security printing box (such as a list of file names of print data, or the like) is displayed on the list screen 61. The user selects the desired print data from the list, and thus can print or delete, or the like, the print data by operating a print button 62 or deletion button 63, etc.

As described above, according to a preferred embodiment of the present invention, when instructing the MFP 2 via the terminal device 3 to perform the security printing, the new registration of the user can be performed along with the instruction for the security printing. Therefore, even an unregistered user or a user unaware of his/her registration content can easily and immediately perform the security printing.

Since the new registration of the user can be performed from the authentication data input screen 46 displayed at the terminal screen 3 for the security printing, the registration can be easily performed.

Furthermore, it is not necessary to install on the terminal device 3 a special software for creating the input screen 46 because the authentication data input screen 46 for the security printing is created by using a browser, which thereby improves convenience.

Various modifications of the configuration according to the above-described preferred embodiments may be adopted. For example, the authentication data input screen 46 displayed at the terminal device 3 may be created by using driver software (such as a printer driver) installed on the control unit 31 for cooperating with the MFP 2.

Furthermore, in place of the storage unit 17 of the MFP 2, the authentication data of the user may be stored in an external server, or the like, connected with the MFP 2 via the network 22.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A printing system comprising:
a printing machine; and
a terminal device connected to the printing machine via a network; wherein
when an instruction for new authentication data registration is provided by the terminal device at a time of receiving an instruction for security printing, the printing machine receives the instruction for the registration; and
when newly received authentication data is input from an operation unit, the printing machine permits printing of print data in accordance with the instruction for the security printing.

2. The printing system according to claim 1, wherein in response to the instruction for the security printing given by the terminal device, when the printing machine confirms that pre-registered authentication data has been input from the operation unit of the printing machine, the printing machine permits the printing of the print data in accordance with the instruction for the security printing.

3. The printing system according to claim 2, wherein:
the terminal device includes a control unit and a display unit;
the control unit displays an authentication data input screen on the display unit for the security printing; and
a registration button is provided on the input screen and arranged to receive the instruction for the new registration from a user.

4. The printing system according to claim 3, wherein the input screen displayed on the display unit of the terminal device is created using a browser installed on the control unit.

5. The printing system according to claim 3, wherein the input screen displayed on the display unit of the terminal device is created by using driver software installed on the control unit and arranged to cooperate with the printing machine.

6. The printing system according to claim 1, wherein the instruction for the security printing is provided at the terminal device when document data to be printed is selected, a printing thereof is instructed, a print setting screen is opened, and settings regarding the security printing are established.

7. The printing system according to claim 4, wherein the input screen is created without requiring installation of special software for creating the input screen.

8. The printing system according to claim 1, wherein the network is one of a Local Area Network or the Internet.

9. A printing method performed by a printing machine and a terminal device that are mutually connected via a network, wherein:
when an instruction for new authentication data registration is provided by the terminal device at the time of receiving an instruction for security printing, the printing machine receives the instruction for the registration; and
when newly received authentication data is input from an operation unit, the printing machine permits printing of print data in accordance with the instruction for the security printing.

10. The printing method according to claim 9, wherein, when the printing machine confirms that pre-registered authentication data has been input from the operation unit of the printing machine in response to the instruction for the security printing given by the terminal device, the printing machine permits the printing of the print data in accordance with the instruction for the security printing.

11. The printing method according to claim 10, wherein:
the terminal device includes a control unit and a display unit;
the control unit displays an authentication data input screen on the display unit for the security printing; and
a registration button is provided on the input screen, and arranged to receive the instruction for new registration from a user.

12. The printing method according to claim 11, wherein the input screen displayed on the display unit of the terminal device is created by using a browser installed on the control unit.

13. The printing method according to claim 11, wherein the input screen displayed on the display unit of the terminal device is created by using driver software installed on the control unit for cooperating with the printing machine.

14. The printing method according to claim 9, wherein the instruction for the security printing is provided at the terminal device when document data to be printed is selected, the printing thereof is instructed, a print setting screen is opened, and settings regarding the security printing are established.

15. The printing method according to claim 12, wherein the method does not include the step of installing software for creating the input screen.

16. The printing method according to claim 9, wherein the network is one of a Local Area Network or the Internet.
